(19) United States
(12) Patent Application Publication
(10) Pub. No.: US 2015/0251149 A1
(43) Pub. Date: Sep. 10, 2015

(54) DEVICE FOR PRODUCING COLORED COSMETIC PRODUCTS

(71) Applicant: APOINTU SOLUTION GmbH, Cham (CH)

(72) Inventor: Ulrich Schwenkmezger, Zeiningen (CH)

(21) Appl. No.: 14/430,278

(22) PCT Filed: Sep. 5, 2013
(86) PCT No.: PCT/DE2013/100316

§ 371 Date: Mar. 23, 2015

(30) Foreign Application Priority Data
Sep. 21, 2012 (DE) 20 2012 009 072.0

(51) Int. Cl. B01F 15/00; B01F 15/02; B01F 3/08; A45D 34/00

(52) U.S. Cl. CPC B01F 15/00318; A45D 34/00; B01F 15/00259; B01F 15/0243; B01F 15/0238; B01F 15/00331; B01F 3/08; B01F 2215/0031

(57) ABSTRACT

An apparatus for producing colored cosmetic products, in particular nail varnish, lip gloss or makeup. The apparatus has a compact structure with a width of at most 50 cm, a height of at most 30 cm, and a depth of at most 20 cm.

The present invention relates to an apparatus for producing colored cosmetic products, in particular nail varnish, lipgloss or make-up.

Colored cosmetic products, for example nail varnish, lipgloss or make-up, are usually marketed as finished products, the number of color variants offered being limited merely because of commercial considerations. Specifically in recent times, however, colored cosmetic products in very individual and specific hues have become desired, which are intended to match the respective occasion, clothes, other accessories, hair color or even the respective surroundings in which the colored cosmetic product is intended to be worn. If all these considerations were taken into account, the users of cosmetic products would be compelled to store a multiplicity of different colored products in order to be able to use a cosmetic product of appropriate or adapted color for a particular occasion, particular clothes, matching a particular accessory or particular surroundings. This would scarcely be reasonable merely for storage or economic reasons, added to which, even then, because of the aforementioned limited available color range, it would not be ensured that the individually desired hue would actually be available.

DE 20 2004 011 856 U1 describes a dispenser for producing mixtures of bodycare products, the composition of the mixture being adapted to the currently measured care requirement. The mixing ratio is established on the basis of currently determined care requirement data. Color aspects do not play a part in the aforementioned utility model.

EP 0 715 543 B1 describes a method and an apparatus for producing customer-specific cosmetic products. The machine is designed to be installed in a department store, and it is also intended to combine and mix differently colored products with one another. The document does not contain any indication of the way in which special hues can be obtained.

EP 0 094 218 B1 describes a method and an apparatus for producing a paint which corresponds to the color values of a standardized liquid paint. The desired paint is prepared on the basis of measured or predetermined color values, the color values determined being based on the Lab color system. The relatively complicated and elaborate method, designed for the large-scale production of paints, is not suitable for the production of individual specific colored cosmetic products for personal requirements.

It is therefore an object of the present invention to provide an apparatus for producing colored cosmetic products, which does not have the disadvantages of the prior art and is suitable for preparing cosmetic products in individual specific colors for personal requirements.

The object is achieved by an apparatus having the features of claim 1. The dependent claims relate to advantageous refinements and embodiments.

Claim 1 relates to an apparatus for producing mixtures of colored cosmetic products, in particular nail varnish, lipgloss and make-up, having a receiving device for receiving two or more replaceable storage containers for colored cosmetic starting products having different base colors, a dispensing device for dispensing the respective colored cosmetic starting products from the storage containers, a control device for controlling the amounts of colored cosmetic starting products to be dispensed, a dosing device for dosing the amounts of colored cosmetic starting products to be dispensed, a mixing device for mixing the respective colored cosmetic starting products, and a delivery device for delivering the final mixtures of the colored cosmetic products, wherein the control device comprises a computer and a program for calculating a mixing ratio required for a desired color from predetermined color data.

The respective color data may be determined using known and commercially available color measuring devices, a preferred configuration of the present invention providing that the color measuring devices be integrated into the apparatus itself and be actively connected to the control device via an electronic data link. For example, colorimeters or spectrophotometers may be used as color measuring devices, any desired different color spaces being usable to describe the measured colors depending on the application, in which case merely the computer and computer program need to be adapted to the respectively selected color space. In a preferred embodiment of the present invention, the color measurement is carried out by means of the spectral method and the color data are represented by means of CIEL*a*b* coordinates.

The use of commercially available color measuring devices, which have corresponding interfaces for data transmission to the control unit, furthermore makes it possible to operate the color measuring devices as a separate unit for the actual color measurement and then transfer the color data determined by corresponding interfaces to the control device.

Besides the aforementioned conventional methods of color measurement, it is also possible to use so-called smartphones with a built-in camera or digital cameras themselves to determine the color data required for the production of a desired cosmetic color mixture. The colors determined by these devices may be transmitted directly or indirectly to the control device, in order for example to be converted there with the corresponding programs into the coordinates of a color space which are required for the mixture production.

According to an advantageous configuration of the present invention, the control device additionally comprises an input device for the input of color data. In this case, the desired color for the colored cosmetic product may be established merely with the aid of color data, without a connection having to be established between a color measuring device and the apparatus for producing colored cosmetic products. Thus, known color data for particular defined colors or also currently measured color data may be used. A particular advantage of this input device is also that the user can vary the color by means of the input device and also achieve experimentally determined color effects, and is thus no longer dependent merely on the measured or known color value for his or her desired color.

In another advantageous configuration of the present invention, starting materials, which for example contain metal sequins or other additives and are stored in additional storage containers, may be added by means of the input device so as to achieve special effects. Furthermore, provision may be made for the input device to comprise a reader for reading color codes. Thus, it is possible to read color codes which are, for example, applied directly to any desired accessories or delivered together with a product and represent the color in an encoded form, so that the cosmetic product matching the color of a corresponding accessory can be produced in a simple way.

In order to ensure automatic conduct of the production of the desired colored cosmetic product, it is necessary for the control device to be actively connected to the dispensing device and the dosing device for the colored cosmetic starting products, or to control them electronically.

A manually operated or electric pump, by which the dosing device is driven, may function as the dispensing device, in which case according to an advantageous configuration of the present invention, the dosing device may be configured as a piston or compression die. Preferably, a separate dosing device is provided for each storage container; in principle it is possible to use any desired dosing device which is based on flow, volume or mass determination.

The mixing device is advantageously configured in such a way that the starting products dispensed in a dosed manner from the storage containers are mixed with one another immediately after they emerge from the storage containers. Preferably, the mixing device comprises a stirring apparatus or a shaking apparatus, by which the colored cosmetic product is homogenized. Depending on the viscosity and the consistency of the colored cosmetic product, it is also possible to use any other desired mixing method.

According to a particularly advantageous configuration of the mixing method, after they have been put into a delivery container in the mixing ratios required for the desired color, the colored cosmetic starting products are transferred in the closed delivery container into a shaking apparatus and homogenized there. The homogenization may in this case be improved by the presence of one or more mixing balls in the delivery container. The shaking apparatus is preferably integrated into the apparatus.

After the mixing, the final colored cosmetic product is transferred into the delivery device for delivery of the desired cosmetic product, and can be taken from there by the user.

Since private use is intended, it is essential for the invention that the apparatus has a compact structure, the width being at most 50 cm, the height being at most 30 cm and the depth being at most 20 cm.

The invention will be explained in more detail below with the aid of a figure.

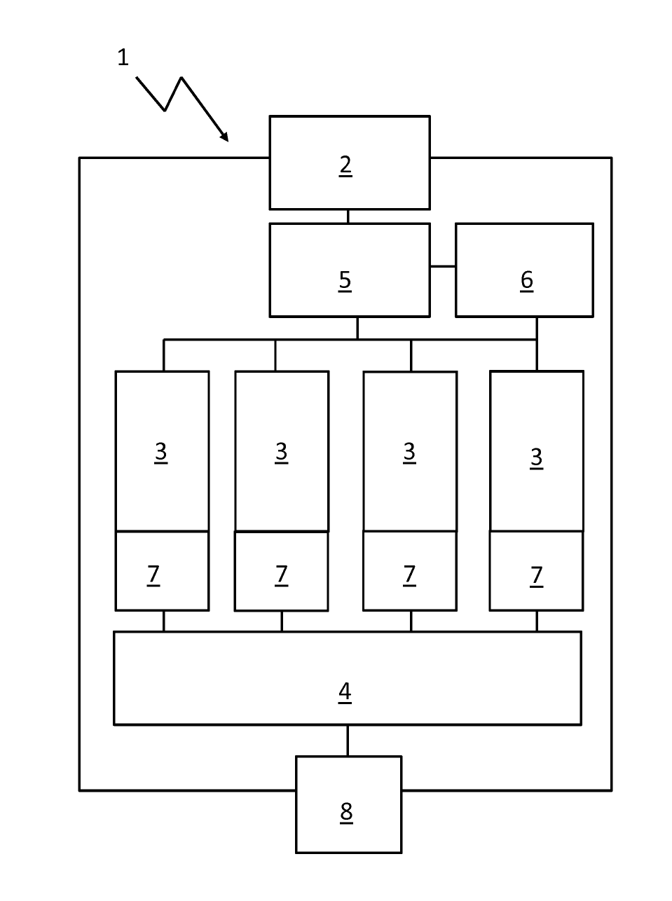

FIG. 1 in question is a schematic representation of an apparatus for producing colored cosmetic products, having a receiving device 1, which is used primarily as a housing for the replaceable storage containers 3 for cosmetic starting products having different base colors. In the representation selected, the storage containers 3 are connected directly to dosing devices 7, the dispensing and dosing of the cosmetic starting products being controlled by means of the dispensing device 6 and the control device 5. In order to control the mixing process, the control device 5, which is actively connected to the dispensing device 6 and to the dosing device 7, comprises a computer and a program for calculating a mixing ratio required for a desired color from predetermined color data. The color data are determined by a color measuring device 2, which is in turn actively connected to the control device 5. From the storage containers 3, the respective colored cosmetic starting products pass through the dosing device 7 into the mixing device 4, where the starting products are mixed with one another and homogenized. By way of example, this is done by means of a stirring or shaking apparatus. Subsequently, the final colored cosmetic product is transferred into the delivery device 8 for delivery of the desired cosmetic product, and can be taken from there by the user.

FIG. 1 as described above merely represents one embodiment of the present invention, and is in particular also not to be regarded as restrictive in relation to the arrangement of the individual units of the apparatus. For example, the color measuring device 2, but also the control unit 5 or the dispensing unit 6, may be arranged outside the receiving unit 1 and, for example, may be docked to the periphery of the housing of the receiving unit 1, where they are then connected via interfaces to the other units. It is also possible to configure the apparatus according to the invention so that, after filling with the colored starting products, the filled delivery container can be taken directly from the apparatus and then shaken by hand or in a separate apparatus, so that the mixing device 4 would in this case also be arranged outside the receiving unit 1.

The present invention provides an apparatus for producing colored cosmetic products, which makes it possible to prepare small amounts of an individual and very specific colored cosmetic product for personal use of the respective user. The user therefore has the possibility of using a colored cosmetic product which matches the respective occasion, clothes, other accessories, hair color or even the respective surroundings. In order to allow straightforward use of the apparatus according to the invention in the private household, for example in the bath or in the dressing room, the apparatus has a compact structure, in a preferred embodiment the width of the apparatus being less than 50 cm, the height less than 30 cm and the depth less than 20 cm.

1-13. (canceled)

14. An apparatus for producing colored cosmetic products, the apparatus comprising:
a receiving device for receiving two or more replaceable storage containers for cosmetic starting products having mutually different base colors;
a dispensing device for dispensing the respective colored cosmetic starting products from the storage containers;
a control device for controlling respective amounts of colored cosmetic starting products to be dispensed, the control device being a computer and a program for calculating a mixing ratio required for a desired color from predetermined color data;
a dosing device for dosing the amounts of colored cosmetic starting products to be dispensed;
a mixing device for mixing the respective colored cosmetic starting products and for producing final mixtures of the colored cosmetic products; and
a delivery device for delivering the final mixtures of the colored cosmetic products.

15. The apparatus according to claim 14, which comprises a color measuring device for determining standardized color data.

16. The apparatus according to claim 15, wherein said color measuring device comprises a digital camera.

17. The apparatus according to claim 15, wherein said color measuring device is operatively connected to said control device.

18. The apparatus according to claim 14, wherein said control device is operatively connected to said dispensing device and to said dosing device.

19. The apparatus according to claim 14, wherein said control device comprises an input device for inputting color data.

20. The apparatus according to claim 19, wherein said input device for inputting color data comprises a reader for color codes.

21. The apparatus according to claim 14, wherein one said dosing device is provided for each storage container.

22. The apparatus according to claim 14, wherein said dosing device is a piston or compression die driven by said dispensing device.

23. The apparatus according to claim 14, wherein said dispensing device comprises a pump.

24. The apparatus according to claim 14, wherein the storage containers contain a pressurized propellant gas and comprise a valve to be controlled by said dispensing device.

25. The apparatus according to claim 14, wherein said mixing device comprises a stirring or shaking apparatus.

26. The apparatus according to claim 14, formed in a compact structure having a width of at most 50 cm, a height of at most 30 cm, and a depth of at most 20 cm.

27. The apparatus according to claim 14, configured particularly for producing colored cosmetic products selected from the group consisting of nail varnish, lipgloss and make-up.
